(19) United States
(12) Patent Application Publication
(10) Pub. No.: US 2008/0308299 A1
(43) Pub. Date: Dec. 18, 2008

(54) Connection Apparatus

(75) Inventors: Ian Stuart Gallagher, Hamilton (NZ); Paul Clifford Reid, Hamilton (NZ); Thomas Stuart Ritchie, Hamilton (NZ)

Correspondence Address: KREMBLAS, FOSTER, PHILLIPS & POLLICK, 7632 SLATE RIDGE BOULEVARD, REYNOLDSBURG, OH, 43068, US

(73) Assignee: GALLAGHER GROUP LIMITED, Hamilton (NZ)

(21) Appl. No.: 11/914,243

(22) PCT Filed: May 12, 2006
(86) PCT No.: PCT/NZ2006/000111

§ 371 Date: Jun. 4, 2008

(30) Foreign Application Priority Data
May 13, 2005 (NZ) 540070

(51) Int. Cl. H01B 17/00

(52) U.S. Cl. 174/168

(57) ABSTRACT

A connection apparatus (1) is provided. The apparatus has: a body (7); at least two connectors (6a, 6b); and an interconnection element (16). The wire connectors (6a, 6b) connect wires to the apparatus (1) and provide a conductive connection of the wires to an interconnection element (16).

### TECHNICAL FIELD

This invention relates to a connection apparatus for wires in electric fence installations. In particular it relates to a connection apparatus for wires of electric fence installations with multiple parallel interleaved live and earthed wires such as those used in electric security fence installations.

### BACKGROUND ART

Electric fence systems are well known within the security industry and are used extensively for preventing movement of people or animals to or from secure areas.

Typically, an electric security fence has wires energised to a predetermined voltage relative to earth. These wires may be referred to as ‘energised’ or ‘live’. An electric fence will also typically have some wires that are ‘earthed’ so that contact with the fence is likely to contact both an ‘energised’ wire and an ‘earthed’ wire.

Usually, the voltage of an energised wire relative to earth is sufficient to provide a deterrent electric shock to prevent the fence being crossed.

In addition to providing a deterrent, the fence may also act as a detector. Any person or animal touching the fence will act as an electric load between an energised wire and earth. The load will reduce the voltage on a wire or across adjacent wires and this voltage drop may be detected to activate an alarm. Detection of a cut in energised wires can similarly be detected as an open circuit. Therefore, a breach of an electric fence can usually be detected as either a load across energised wires and earth or as an open circuit between the extreme ends of energised wires and earthed wires.

A security fence forming a perimeter will typically be divided into relatively short sections so a breach of the fence can be located by the section in which it occurred.

Sections of a security fence might typically be 100 metres long.

The security fence may also be divided into vertical zones so that a breach can be isolated further. A typical electric security fence may have up to thirty parallel wires separated by a vertical spacing which is small enough to prevent people or animals getting between the wires without contacting adjacent wires.

The live wires in an electric security fence section are typically connected in a continuous path of wires connected in series between two end terminals.

To configure a section of an electric security fence to have all live wires in series, ends of the wire sections are alternately connected to wires above and below so that the path of live wire sections zig-zags down the electric security fence section. This configuration is illustrated in FIG. 5.

The earth wires in an electric security fence are, typically, configured as a grid of parallel wires, interconnected in parallel at both ends of their run.

The interconnection of ends of wire sections to those below is conventionally made by connecting a short piece of wire with joint clamps at each end between the two wires.

The connection of potentially large numbers of joint clamps to the wires is a labour intensive task which adds to the cost of electric security fence installations.

These interconnections are also visually intrusive and vulnerable to accidental or intentional damage.

It is an object of one aspect of the present invention to provide a connection apparatus for fences which facilitates configuration of electric fences with relatively reduced labour, or at least to provide the public with a useful choice in interconnection apparatus.

It is an object of an aspect of the present invention to provide a visually tidy and less vulnerable interconnection.

Where a security fence installation includes an inside corner post, the post may create an unprotected area where a person might climb over the fence without touching wires that pass on the other side of the post.

It is an object of one aspect of the present invention to provide a connection apparatus that provides electric elements spanning between wire strands at an inside corner of the fence to provide an electric fence barrier against access to the post.

It is an object of one aspect of the present invention to address the foregoing problems or at least to provide the public with a useful choice.

Further aspects and advantages of the present invention will become apparent from the ensuing description which is given by way of example only.

As used herein the term ‘interconnection’ and suchlike is intended to broadly refer to a mutual connection of two of more entities and explicitly includes directional interconnection with directional or non-isotropic characteristics.

As used herein the term ‘electric’ refers generally to fences with electrical characteristics which may be passive or active. This is, the ‘electric fence’ may be active and sufficiently energised to a deterrent voltage or may be passive and substantially not energised but used merely for electrical detection purposes.

As used herein the terms ‘insulating’ or ‘insulate’ or such like are intended to refer to preventing conduction to some degree. The degree of prevention will be apparent to the skilled addressee when considering given applications of the present invention.

As used herein the terms ‘conduction’, ‘conductive’ or such like are intended to include, but not be limited to electrical conduction, conduction with directional or non-isotropic characteristics.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the invention there is provided a connection apparatus which includes:
at least one interconnection element adapted to provide a conductive path between two or more points, and
a body, and
at least two wire connectors adapted to secure wires to the body,
wherein the at least two wire connectors are capable of providing a conductive connection to said at least one interconnection element.

Preferably the wire connectors are adapted to secure the interconnection element to the body.

Preferably said body includes at least one interconnection recess to receive the at least one interconnection element.

Preferably the interconnection element is removable from the rest of the apparatus.

Preferably the body includes at least two interconnection recesses running substantially between wire connectors.

Preferably the body conductively isolates interconnection elements it receives from each other.

Preferably the wire connector is configured to connect a wire to any one of two interconnection elements received by the interconnection recesses of the body.

Preferably the wire connectors are distributed along the length of the body.

Preferably the body includes at least one wire engagement recess.

Preferably a wire engagement recess is substantially at right angles to the long side of the body so the body can be mounted by a wire engagement recess on a wire.

Preferably the wire connector is adapted to retain a wire within the wire engagement recess.

Preferably a wire engagement recess of the body is defined by at least one hook.

Preferably a wire connector includes a conductive link element.

Preferably a conductive link element includes a screw.

Preferably the body includes at least one link passage for the wire connector, said link passage extending from a wire engaging recess to an interconnection recess.

Preferably a link passage includes an insulating diaphragm adapted to be pierced by the conductive link element.

Preferably the body includes at least two said link passages, each link passage extending to a different interconnection recess.

Preferably the interconnection element is adapted to deform to retain the conductive link element in said interconnection element.

Preferably the interconnection element includes at least one helix shaped aperture adapted to be deformed by a screw.

Preferably the body includes a guard portion configured to receive a portion of the conductive link element extending past the interconnection element if it extends past the interconnection element.

Preferably the body is adapted such that said bodies are capable of being joined at their ends.

Preferably the body includes inter guard deca at each end to facilitate endstacking on installation.

Preferably the body is substantially formed from an insulating material.

Preferably the insulating material is a plastic.

### BRIEF DESCRIPTION OF DRAWINGS

Further aspects of the present invention will become apparent from the following description which is given by way of example only and with reference to the accompanying drawings in which:

FIG. 1 shows a perspective view of a portion of a connection apparatus according to one embodiment of the present invention;

FIG. 2 shows a cut-away side view of a connection apparatus according to the same embodiment of the present invention;

FIG. 3 shows a perspective view of a connection apparatus according to the same preferred embodiment of the present invention as FIGS. 1 and 2;

FIG. 4 shows a perspective view of an interconnection element according to the same preferred embodiment as FIGS. 1 to 3;

FIG. 5 shows a typical wiring configuration showing a zig-zag path of wire interconnections;

FIG. 6 schematically shows two connection apparatus according to the same embodiment of the present invention as FIGS. 1 to 4 where the connection apparatuses are used to establish a zig-zag path of wire sections interconnected in series.

FIG. 7 shows two connection apparatuses according to the same embodiment as FIGS. 1 to 4 and 6 as used to interconnect two sections of wire at a corner of a security fence installation and provide security fence elements that span these.

### BEST MODES FOR CARRYING OUT THE INVENTION

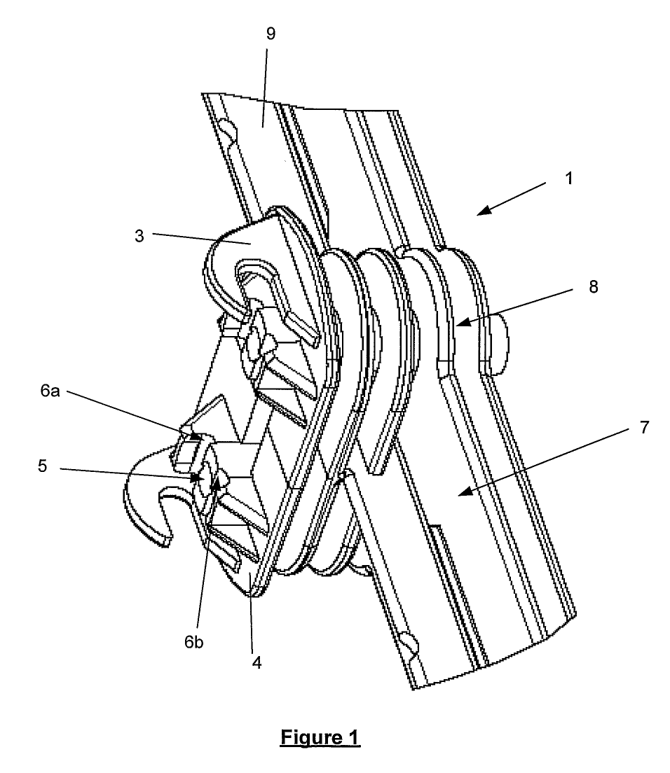

FIG. 1 shows a section of an connection apparatus 1. The connection apparatus 1 has hooks 3, on a mounting plate 4. The mounting plate has screw holes 5, leading to link passages, or bores 11. The link passages 11 receive conductive link elements, or screws 2.

The connection apparatus 1 has a main body 7 with interconnection recesses formed down the length of the body 7. An interconnection recess 8 extends into the body 7 as far back as a central support 9. In the preferred embodiment, the body 7 has two interconnection recesses 8 extending in parallel and separated by the central support 9. The central support 9 conductively isolates the two recesses 8 and also provides structural support for the main body 7.

The hooks 3 define a wire engagement recess 6a which are aligned with the plane of the mounting plate 4 and are at right angles to the main body 7 of the connection apparatus 1. The hooks 3 can be used to engage a wire 14 to mount the connection apparatus on the wire.

A second engagement recess 6b is available for connecting a second wire.

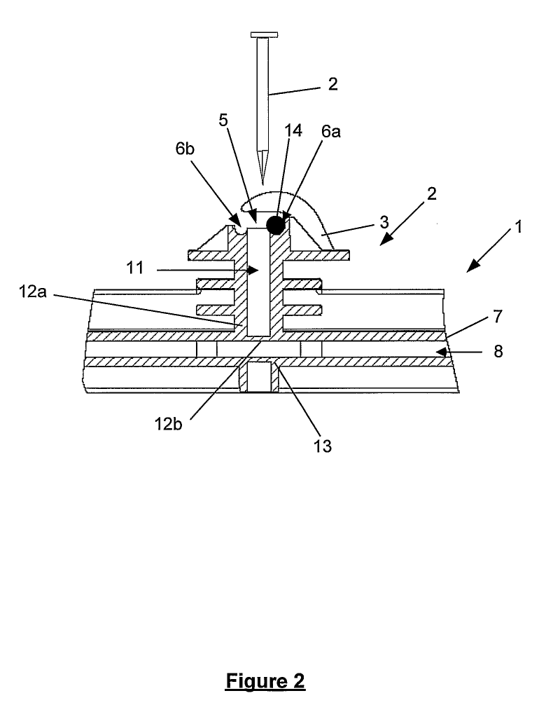

Referring now to FIG. 2, the bore, 11 extends from the wire engagement recess 6a of the hook 3. It also extends through the mount 12a and through the interconnection recess 8 to a guard portion 13. The bone 11 is blocked by a diaphragm 12b prior to a screw 2 being inserted.

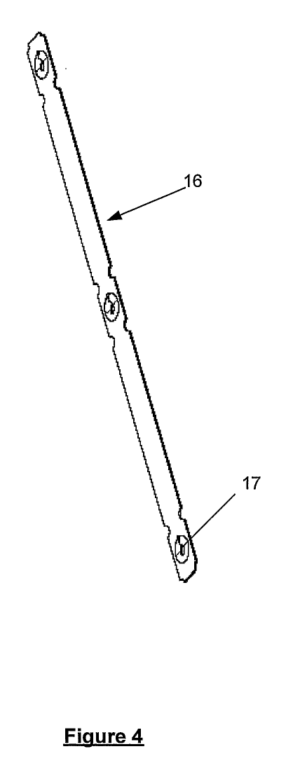

The screw 2, bore 11 and guard portion 13 allow the interconnection element 16 (shown in FIG. 4), to be secured to the body 7. The bore 11 is initially blind, due to the diaphragm 12b, and provides an insulating barrier between the wire and the interconnection element unless penetrated by a screw 2. The screw 2 typically extends through the interconnection element 16 and the overshoot is received by the guard portion 13.

The interconnection recess 6a is positioned to one side of the central axis of the bore 11 so that a screw 2 placed in the bore 11 would force a wire 14 to the back of the wire engagement recess 6a to retain it there. This action secures the wire 14 to the body 7. A second wire (not shown) engaged in the interconnection recess 6b may be secured by the same screw 2.

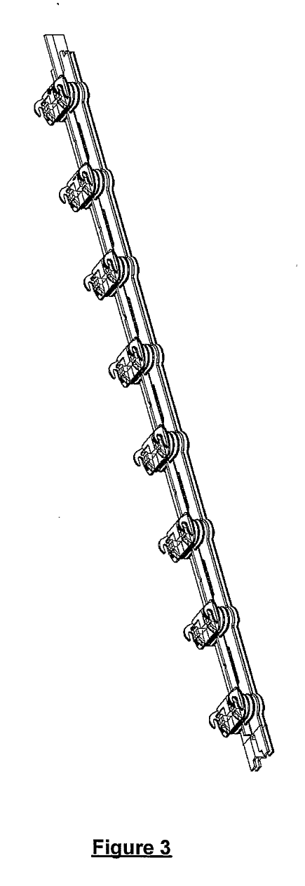

The interconnection recess 6a is aligned at right angles with the body 7 of the interconnection apparatus 1 to allow it to extend, or hang, from a wire. As shown in FIG. 3, the interconnect 1 is typically formed from a number of portions such as shown in FIGS. 1 and 2. These figures show the connection apparatus 1 hung from a number of parallel wires 14.

FIG. 4 shows a conducting element or interconnection element 16. The interconnection element 16 provides conductive interconnection between points along its length.

In the preferred embodiment, the interconnection element 16 is a metallic strip which includes pressed helix apertures 17 which receive a screw 2 located in the bore 11. Each pressed helix aperture 17 is deformed by the screw 2 and acts upon the thread of the screw to retain the screw 2 in the interconnection element and against the wire 14. The same action secures the interconnection element 16 to the body 7 in the interconnection recess 8. In the preferred embodiment, the interconnection element 16 is removable from an interconnection recess 8 in the body 7, when the interconnection element 16 is not secured by a screw 2.

An interconnection element 16 received in a recess 8 extends along the main body 7 to run from one wire connector 2 to another.

The pressed helix apertures 17 are spaced to match multiples of spacing on the main body 7 of the bores 11. Typically, the spacing is matched to twice the distance between adjacent bores 11. The skilled addressee will appreciate that any multiple of that distance may be substituted for given applications of the connection apparatus.

The helix apertures permit stacking of the interconnection elements 16 to provide an extended interconnection element (not shown). The helix shaped apertures are adapted to nest with a corresponding helix shaped aperature of a second interconnection element to provide an extended length interconnection element.

The screw 2 is metallic and therefore acts as a conductive link element, forming an electrical connection between the wire 14 and a point along the interconnection element 16.

The wire connector 2 has two screw holes 5, each with corresponding bores 11. Each bore 11 is associated with a different parallel recess 8. This allows the wire 14 to be alternatively connected to either interconnection element 16 in respective parallel interconnection recesses 8.

The connection apparatus 1 can be hooked onto a wire 14 by the hook 3 before the screw 2 is inserted into one of the available bores 11, to secure an interconnection element 16 in a recess 8 a wire 14 to the body 7.

The main body of the connection apparatus 1 is typically formed from a high density polyurethane, which is an electrically insulating material, so the interconnection elements 16 received in opposite recesses 8, shown in FIGS. 1 to 3, are conductively isolated from each other.

The connection apparatus may have features which allow two or more apparatus to be stacked end-on-end to accommodate particularly high fences. In the preferred embodiment, the body 7 has inter guard deca (not shown) at each end which allows the body 7 to be joined or stacked during installation of the connection apparatus 1.

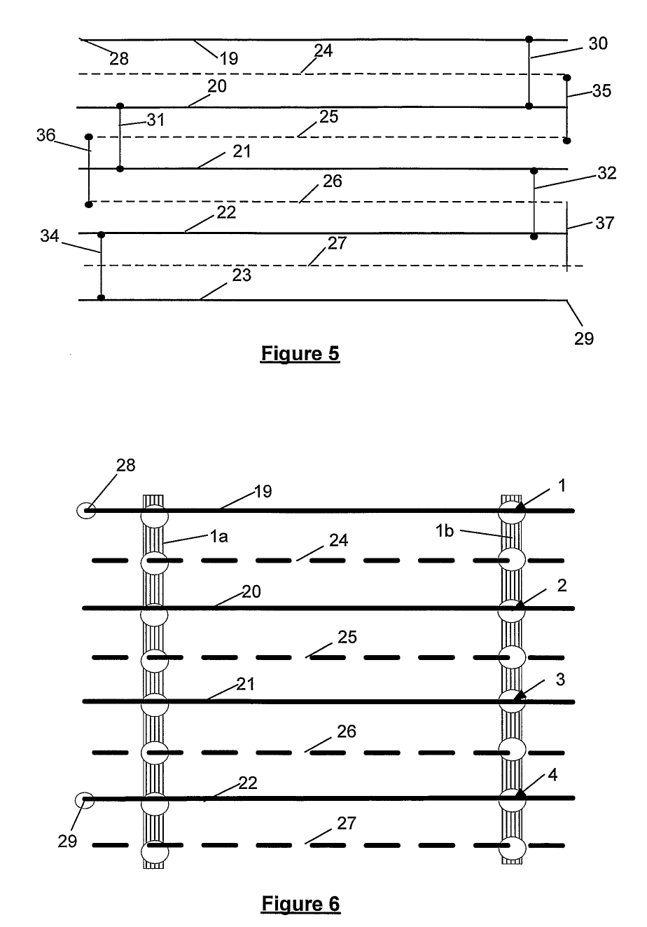

FIG. 5 schematically shows a typical configuration for an electric security fence. Energised wires are denoted by solid lines, 19 to 23, and earthed wires are denoted by broken lines, 24 to 27. Typically, the electric security fence will be configured so that a conducting path is formed in a ‘zig-zag’ from the top terminal 28 to the bottom terminal 29. Adjacent energised terminals, for example, are connected at alternate ends by interconnection elements 30 to 34. The configuration shown in FIG. 5 allows for a cut in one of the wires 19 to 23 to be detected as an open circuit between terminals 28 and 29. Earthed wires 24 to 27 are shown connected in a similar fashion to the energised wires 19 to 23 although they may in this case often typically be connected in parallel rather than series.

Referring to FIG. 6, two connection apparatus 1a and 1b are shown as they would be used to create the electric security fence configuration described with reference to FIG. 5.

The connection apparatus 1a and 1b hang from multiple wires 19 to 27. The interconnection lengths 30 to 34 may be provided by interconnection elements 16 which are inserted into interconnection recesses 8 and held into place by screws 2 and bores 11. The screws 2 also electrically connect the interconnection elements 16 to the wires 19 to 27. Interconnections between alternate energised wires may be provided by interconnection elements 16 placed in recesses in the right hand side of the connection apparatuses 1a and 1b, for example. Whereas interconnection of earthed wires may be provided by interconnection elements received in recesses 8 on the left hand side of connection apparatuses 1a and 1b, for example. Parallel interconnection elements 16 on opposite sides of the same connection apparatus are separated and isolated from each other by the central support 9. The wires 19 to 27 are connected to an interconnection element 16 in an appropriate recess 8 by the choice of screw hole 5.

To arrange a configuration of electric security fence such as shown in FIGS. 5 and 6 an installation technician may first hang two connection apparatus 1 from the wires in the electric security fence. The technician may then simply insert interconnection elements 16 into interconnection recesses 8 and insert screws 2 into the side of the connection apparatus 1 in which the interconnection element is received. Tightening the screw 2 would electrically connect the wire to the interconnection element and, by the same action, secure the wire to the connection apparatus 1. The technician would then add a screw to the same side of the connection apparatus 1 at the other end of the interconnection element 16 to connect the next energised wire to the connection apparatus 1 and the first wire. The technician would repeat the process on the opposite side of the same connection apparatus 1 to configure interconnection of earthed wires.

The action of hanging a single interconnect with multiple wire connections 2 to multiple wires, inserting interconnection elements 16 into the side of the connection apparatus 1, and inserting and tightening screws requires relatively minimal labour for interconnection of a relatively large number of wires, as compared to using wires and clamps.

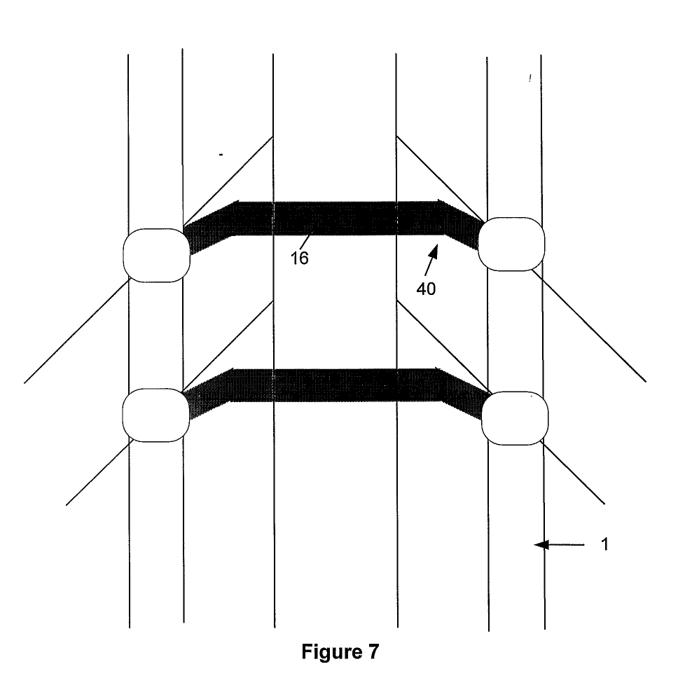

FIG. 7 shows an alternative use of the connection apparatus 1 where interconnection of wires on the inside of a post, for example, is provided by interconnection elements 16 running horizontally between different connection apparatuses 1. At the same time the metallic interconnection elements 16 act as security fence elements that can be either ‘energised’ or ‘earthed’. In this situation the interconnection elements 17 may be adapted with a bend 40.

In this use the interconnection element 16 would extend laterally from the main body 7, as shown in FIG. 7. It would also extend laterally from another connection apparatus connected to another section of the wire at the other side of a post. Thus the interconnection element 16 extends between two separate connection apparatus 1c and 1d.

The present invention provides a connection apparatus that has the advantage of convenient and labour efficient means to configure interconnections of a security fence. The interconnection apparatus can be hung from wires and conductive interconnections can be configured subsequently by the addition of interconnection elements and the addition of wire connection elements that conductively connect wires to the interconnection elements.

The present invention also provides a means to provide the inside corners of electric fence installations with electric fence elements that span the corner over a post.

Aspects of the present invention have been described by way of example only and it should be appreciated that modifications and additions may be made thereto without departing from the scope thereof as defined in the appended claims.

1. A connection apparatus which includes:
at least one interconnection element adapted to provide a conductive path between two or more points, and
a body, and
at least two wire connectors adapted to secure wires to the body,
wherein the at least two wire connectors are capable of providing a conductive connection to said at least one interconnection element,
and wherein the wire connectors are adapted to secure the interconnection element to the body.

2. The connection apparatus of claim 1, wherein said body includes at least one interconnection recess to receive the at least one interconnection element.

3. The connection apparatus of claim 2 wherein an interconnection element is removable from an interconnection recess.

4. The connection apparatus of claim 2, wherein the body includes at least two interconnection recesses running substantially between wire connectors.

5. The connection apparatus of claim 2, wherein the body electrically isolates the interconnection elements it receives from each other.

6. The connection apparatus of claim 4, wherein a wire connector is configured to connect a wire to any one of two interconnection elements received by the interconnection recesses of the body.

7. The connection apparatus of claim 1 wherein the wire connectors are distributed along the length of the body.

8. The connection apparatus of claim 1 wherein a wire connector includes a conductive link element.

9. The connection apparatus of claim 8 wherein the conductive link element includes a screw.

10. The connection apparatus of claim 1 wherein a wire connector defines at least one wire engagement recess.

11. The connection apparatus of claim 10, wherein the wire engagement recess is oriented substantially at right angles to the length of the body so the body can be mounted by the wire engagement recess on a wire.

12. The connection apparatus of claim 11 wherein a wire engagement recess of the connector is defined by at least one hook.

13. The connection apparatus of claim 10, wherein the wire connector is adapted to retain a wire within a wire engagement recess.

14. The connection apparatus of claim 13 wherein a conductive link element is adapted to retain a wire in at least one of the wire engagement recesses.

15. The connection apparatus of claim 10 wherein a wire connector defines two wire engagement recesses.

16. The connection apparatus of claim 10, wherein the body includes at least one link passage for a conductive link element, said link passage extending from a wire engaging recess to an interconnection recess.

17. The connection apparatus of claim 16 wherein a link passage includes an insulating diaphragm adapted to be pierced by a conductive link element when the link element is inserted into said link passage.

18. The connection apparatus of claim 16, wherein the body includes at least two link passages for each wire provided, each link passage extending to a different interconnection recess.

19. The connection apparatus of claim 8, wherein the interconnection element is adapted to deform to retain the conductive link element in said interconnection element.

20. The connection apparatus of claim 19, wherein the interconnection element includes at least one helix shaped aperture adapted to be deformed by a screw.

21. The connection apparatus of claim 20 wherein the helix shaped aperture is adapted to nest with a corresponding helix shaped aperture of a second interconnection element to provide an extended length interconnection element.

22. The connection apparatus of any one of claim 8, wherein the body includes a guard portion configured to receive a portion of the conductive link element extending past the interconnection element.

23. The connection apparatus of claim 1 wherein the body is formed from an insulating material.

24. The connection apparatus of claim 23, wherein the insulating material is a plastic.

25. (canceled)
